(19) United States
(12) Patent Application Publication
(10) Pub. No.: US 2016/0371785 A1
(43) Pub. Date: Dec. 22, 2016

(54) APPARATUS AND METHODS FOR PRESCRIPTIVE ANALYTICS

(71) Applicant: AutoClaims Direct Inc., Carlsbad, CA (US)

(72) Inventor: ERNEST B. BRAY, Escondido, CA (US)

(21) Appl. No.: 14/742,343

(22) Filed: Jun. 17, 2015

(51) Int. Cl. G06Q 40/08; G06Q 30/06

(52) U.S. Cl. CPC G06Q 40/08; G06Q 30/0631

(57) ABSTRACT

Apparatus and methods for utilizing prescriptive analytics (PA) to examine a current incident against a plurality of previous incident data. In one embodiment, a PA server accesses a collection of data having a plurality of measurable features in order to prescribe and implement a course of action. The measurable features of the collection of data are compared to measurable features of new data, to arrive at conclusions regarding e.g., a service which is needed, damage and settlement estimates, and fraud. The PA server causes a client device to be forwarded to the appropriate service (such as a web-application, a live agent, a repair facility, and/or a salvage entity, etc.). In addition, the PA server causes one or more service entity devices to proceed with a prescribed course of action according to the determined estimates.

### BACKGROUND

1. Technological Field

The disclosure relates to managing a collection of data in order to prescribe and implement a course of action. In one exemplary aspect, the disclosure relates to a system for collecting data regarding insurance claims for property damage and/or personal injury and using this data to more efficiently process new claims, including forwarding a user to the appropriate service, estimating settlement, fault, and/or repairs, and using the data to detect fraud.

2. Description of Related Technology

As the number of vehicles on the roadways increases, so too does the number of vehicle collisions. An extent of damage to property as well as personal injury to the parties involved may range from minor to quite extensive. Commonly, it is the role of an insurance agent or adjuster is to determine whether a particular insurance policy will cover repairs and/or medical treatment resulting from a collision given the details surrounding the incident. Similar concepts apply to other property which is susceptible to loss or damage such as for example homes, appliances, commercial vehicles and equipment, public transportation vehicles, etc., and to other non-property related personal injuries or medical conditions.

Referring again to the vehicle collision example, it is well known that the vast majority of collisions are considered minor incidents, and result in property damage which is easily repaired. In an instance where damage is extensive and personal injuries are severe, more complicated repairs may be warranted (or the vehicle may be considered a total loss) and emergency or non-emergency medical treatment may be needed. In either case, under current technologies, the user must determine an appropriate means of informing the insurance company about the incident, and the insurance agent must process the claim. Similar concepts apply to the previously referenced other properties and injuries/medical conditions.

The present modes of determining which service to provide, and estimating repairs/damage, time to completion, fault, etc., rely heavily on findings of fact performed by a trained professional. These intensive discoveries are performed de novo at each new incident report. That is to say, at each new reported incident the insured must provide all relevant facts relating to the incident, the insurer must then evaluate these facts in a vacuum to determine how next to proceed, etc. In the interim, a large pool of data is collected regarding each incident, however it is too large and largely unformatted and therefore cannot be accessed and/or utilized by the insurer.

Accordingly, despite the foregoing systems and methods, there is still a salient need for more efficient, reliable, and timely techniques and apparatus for collecting data regarding insurance claims for property damage and/or personal injury and using this data to more efficiently process new claims, including forwarding a user to the appropriate service, estimating settlement, fault, and/or repairs, and using the data to detect fraud. Such improved techniques and apparatus should, ideally, reliably provide a mechanism for taking into account historical data relating to demography, geography, and settlement of previously submitted insurance claims. Such techniques and apparatus should also ideally be compatible with personal electronics and networking technologies. Still further, exemplary apparatus would be adapted to provide an automatic connection of a user to an appropriate service, including situations where little to no information is provided by the user.

### SUMMARY

The present disclosure addresses the foregoing needs by providing, inter alia, methods and apparatus for managing a collection of data in order to prescribe and implement a course of action.

In a first aspect, an apparatus configured to prescribe a user action based on a plurality of historical data is provided. In one embodiment, the apparatus comprises: (i) at least one interface configured to: communicate with a user device, the user device configured to provide a first data record comprising information relating to a first incident and communicate with at least one historical database, the at least one historical database comprising a plurality of second data records, each of the second data records corresponding to individual ones of a plurality of second incidents; (ii) a storage apparatus; and (iii) a processor in communication with the storage apparatus and configured to execute at least one computer program stored thereon, the computer program comprising a plurality of instructions.

In one implementation, the instructions are configured to when executed by the processor: compare one or more aspects of the first data record to one or more patterns identified in the plurality of second data records to identify one or more patterns to which the first data record corresponds; and cause the user device to be automatically connected to a specific one of a plurality of services based at least in part on the identified one of the one or more patterns.

In another implementation, the instructions are configured to when executed by the processor: examine the plurality of second data records to extrapolate one or more patterns therein; receive the first data record relating to the first incident; format the first data record into a format configured to correspond to a format utilized by the at least one historical database for the plurality of second data records; compare one or more aspects of the first data record to the one or more patterns to identify one of the one or more patterns to which the first data record corresponds; and cause the user device to be automatically connected to a specific one of a plurality of services based at least in part on the identified one of the one or more patterns.

In a second aspect, a method for connecting a user to a service needed at a time of an incident (such as e.g., one involving property damage) in real-time is disclosed. In one embodiment, the method comprises: (i) receiving information relating to the incident, the information comprising values of certain ones of a plurality of measurable factors; (ii) deriving a data record from the information, the data record configured to correspond to a format of a plurality of historical data records; (iii) comparing the values of the data record to respective values of individual ones of a plurality of measurable factors of each of the plurality of historical data records; and (iv) when a threshold number of the values of the data record correspond to the values of individual ones of the plurality of measurable factors of a first one of the plurality of historical data records, causing the user to be automatically connected to a service associated with the first one of the plurality of data records.

In one particular implementation, the method comprises: (i) receiving a plurality of historical data records, each of the plurality of historical data records being configured to represent a respective one or more of a plurality of specific historical incidents and having a first plurality of data entries comprising values for each of a respective plurality of measurable factors, and a second data entry comprising a service to which the specific historical incident may be routed; (ii) classifying the plurality of historical records into one or more classes based on the service to which the specific historical incident may be routed; (iii) receiving information relating to the incident, the information comprising values of certain ones of the plurality of measurable factors; (iv) deriving a data record from the information, the data record configured to correspond to a format of the plurality of historical data records; (v) comparing the values of the data record to the values of individual ones of the plurality of measurable factors of each of the classes of the historical data records; and (vi) when a threshold number of the values of the data record correspond to the values of individual ones of the plurality of measurable factors of a first one of the one or more classes, causing the user to be automatically connected to the service associated with the first one of the one or more classes.

In a third aspect, a non-transitory computer readable apparatus comprising a storage medium is disclosed. In one embodiment, the storage medium comprises at least one computer program having a plurality of instructions, the plurality of instructions configured to, when executed by a processing apparatus: (i) obtain data regarding a current incident from a party to the incident; (ii) receive a plurality of historical data regarding a plurality of previous incidents from one or more historical databases; and (iii) compare the data regarding the current incident to the plurality of historical data and based on the comparison cause one or more entities in communication therewith to automatically perform an action.

In one particular implementation, the instructions, when executed: (i) obtain data regarding a current incident from a party to the incident; (ii) receive a plurality of historical data regarding a plurality of previous incidents from one or more historical databases; and (iii) compare the data regarding the current incident to the plurality of historical data and based on the comparison: determine whether the incident is fraudulent; cause a user device associated with the party to be automatically forwarded to a resolution service; provide a determination of fault associated with the incident; provide an estimate of an amount which repairs associated with the current incident will cost; and provide an estimate of an amount which settlement for injuries associated with the current incident will cost.

In another aspect, a system is disclosed. In one embodiment, the system comprises at least one user device, a server apparatus configured to perform data mining with respect to a plurality of databases in communication therewith, and an interface by which the server may communicate with the plurality of databases and with the at least one user device. In one embodiment, the data mining enables the server apparatus to perform at least one decision-making function on behalf of the at least one user device based on information obtained therefrom in comparison with data obtained from said plurality of databases. In a further variant, the decision-making function further comprises causing the at least one user device to be forwarded to a service providing entity.

These and other aspects of the disclosure shall become apparent when considered in light of the detailed description provided herein.

Other features and advantages of the present disclosure will immediately be recognized by persons of ordinary skill in the art with reference to the attached drawings and detailed description of exemplary embodiments as given below.

### BRIEF DESCRIPTION OF THE DRAWINGS

FIG. 1 is a block diagram illustrating an exemplary architecture for utilizing a prescriptive analytics (PA) server of the present disclosure for managing a collection of data in order to prescribe and implement a course of action.

FIGS. 2A-2E are block diagrams illustrating exemplary weighting tables for use in enabling manipulation of a weight applied to a number of measurable factors in accordance with the present disclosure.

FIGS. 2F-2G are block diagrams illustrating exemplary incident records for use in managing a collection of data in order to prescribe and implement a course of action in accordance with the present disclosure.

FIG. 3 is a logical flow diagram illustrating an exemplary method of employing the PA server of FIG. 1 to manage a collection of data in order to prescribe and implement a course of action in accordance with the present disclosure.

FIG. 4 is a block diagram illustrating an exemplary PA server configuration in accordance with the present disclosure.

All figures © Copyright 2015 Auto Claims Direct Inc. All rights reserved.

### DESCRIPTION OF THE DISCLOSURE

Reference is now made to the drawings listed above, wherein like numerals refer to like parts throughout.

As used herein, the term “application” refers generally and without limitation to a unit of executable software that implements theme-based functionality The themes of applications vary broadly across any number of disciplines and functions (such as e-commerce transactions, shipping transactions, entertainment, calculator, Internet access, etc.), and one application may have more than one theme. The unit of executable software generally runs in a predetermined environment; for example and without limitation, the unit could comprise a downloadable Java Xlet™ that runs within the JavaTV™ environment.

As used herein, the terms “client device,” and “user device” include, but are not limited to, personal computers (PCs), whether desktop, laptop, or otherwise, personal digital assistants (PDAs) such as the “Palm®” family of devices, cellular or “smart” phones such as the Apple iPhone, handheld computers, J2ME equipped devices, personal media devices, set-top boxes, or literally any other device capable of interchanging data with a network. Such devices may interface using wired or optical fiber mechanisms such as an IEEE Std. 802.3 Ethernet interface, Digital Subscriber Line (DSL), DOCSIS modem, hybrid fiber-coax (HFC) cable, FireWire (IEEE Std. 1394), or alternatively via wireless mechanisms and protocols such as 3GPP/3GPP2, Bluetooth™, IrDA interface, IEEE Std. 802.11, UWB (e.g., IEEE-Std. 802.15 or similar), WiMAX (802.16), Wireless Application Protocol (WAP), GPRS, GSM, or any other of myriad data communication systems and protocols well known to those of skill in the communications arts.

As used herein, the term “computer program” is meant to include any sequence of human or machine cognizable steps which perform a function. Such program may be rendered in virtually any programming language or environment including, for example, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.) and the like.

As used herein, the term “database” refers generally to one or more tangible or virtual data storage locations, which may or may not be physically co-located with each other or other system components.

As used herein, the term “digital processor” is meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable compute fabrics (RCFs), array processors, and application-specific integrated circuits (ASICs). Such digital processors may be contained on a single unitary IC die, or distributed across multiple components.

As used herein, the term “display” means any type of device adapted to display information, including without limitation CRTs, LCDs, TFTs, plasma displays, LEDs, and fluorescent devices.

As used herein, the term “interface” includes, without limitation, software-based interfaces (e.g., application programming interfaces, or APIs), user interfaces (e.g., GUIs), and/or hardware-based interfaces (such as e.g., Ethernet, Wi-Fi, optical interface devices), including any combinations of the foregoing.

As used herein, the term “memory” includes any type of integrated circuit or other storage device adapted for storing digital data including, without limitation, ROM, PROM, EEPROM, DRAM, SDRAM, DDR/2 SDRAM, EDO/FPMS, RLDRAM, SRAM, “flash” memory (e.g., NAND/NOR), and PSRAM.

As used herein, the term “network” refers generally to data or communications networks regardless of type, including without limitation, LANs, WANs, intranets, internets, the Internet, cable systems, telecommunications networks, satellite networks, and Virtual Private Networks (VPNs), or collections or combinations thereof, whether based on wired, wireless, or matter wave modalities. Such networks may utilize literally any physical architectures and topologies (e.g. ATM, IEEE-802.3, X.25, Token Ring, SONET, 3G/3GPP/UMTS, 802.11, 802.16, 802.15, Hybrid fiber-coax (HFC), etc.) and protocols (e.g., TCP/IP, HTTP, FTP, WAP, GPRS, RTP/RTCP, etc.).

As used herein, the term “speech recognition” refers to any methodology or technique by which human or other speech can be interpreted and converted to an electronic or data format or signals related thereto. It will be recognized that any number of different forms of spectral analysis (such as MFCC (Mel Frequency Cepstral Coefficients) or cochlea modeling, may be used. Phoneme/word recognition, if used, may be based on HMM (hidden Markov modeling), although other processes such as, without limitation, DTW (Dynamic Time Warping) or NNs (Neural Networks) may be used. Myriad speech recognition systems and algorithms are available, all considered within the scope of the disclosure disclosed herein.

As used herein, the term “vehicle” refers without limitation to any form of air, land or water transportation for either person, animals, and/or inanimate objects including, without limitation, buses, cars, sports utility vehicles, all-terrain vehicles, motorcycles, boats, airplanes, helicopters, drones, ships, etc.

### Overview

The present disclosure provides, inter alia, methods and apparatus for prescriptive analytics. In one embodiment, a prescriptive analytics (PA) server accesses a collection of data in order to prescribe and implement a course of action. The collection of data is collected over e.g., an extended period of time (and/or extensive number of events, irrespective of time), and incorporates a plurality of measurable features. The measurable features of the collection of data are compared to measurable features associated with newly obtained data, to arrive at various conclusions regarding what precise service is needed, damage and settlement estimates, potential for fraud. The PA server is then able to cause a client device associated with the newly obtained data to be forwarded to the appropriate service. In addition, the PA server causes one or more service entity devices to proceed according to the determined estimates.

In one exemplary aspect, the collected data comprises data regarding insurance claims for property damage and/or personal injury. The data may be collected over a moving window, or may comprise an unfiltered amount of data. Moreover, the data may be pulled from one or more databases having verified information stored thereon. The PA server uses this data to more efficiently process new insurance claims, including forwarding a customer to the appropriate service (such as a web-application, a live agent, a repair facility, and/or a salvage entity, etc.). Moreover, the PA server estimates settlement, fault, and/or repairs and uses the data to detect fraud. These estimates are used by the PA server to cause the repair facility and/or insurance agent to proceed with a prescribed course of action.

Methods of operating the network(s), devices, and for doing business are also described.

### Description of Exemplary Embodiments

It is noted that while the system and methods of the disclosure described herein are discussed with respect to an exemplary embodiment relating to delivery of information regarding insurance claims for vehicles, certain aspects of the disclosure may be useful in other applications, including, without limitation, other types of items having insurance, such as other chattel (including e.g., homes, jewelry, electronics or other such items) and/or incidents which do not involve property damage, yet which involve personal injury or illness.

Moreover, it will be recognized that while described substantially in terms of a single event (e.g., auto accident) or logical thread (e.g., PA analysis and course of action), the present disclosure contemplates both (i) operation of the PA and other analyses described herein on multiple different events, which may or may not be related to one another in terms of geography, time, involved party or parties, etc.; and (ii) processing of various data in parallel (versus e.g., a single substantially serial logical thread).

### Prescriptive Analytics (PA) System—

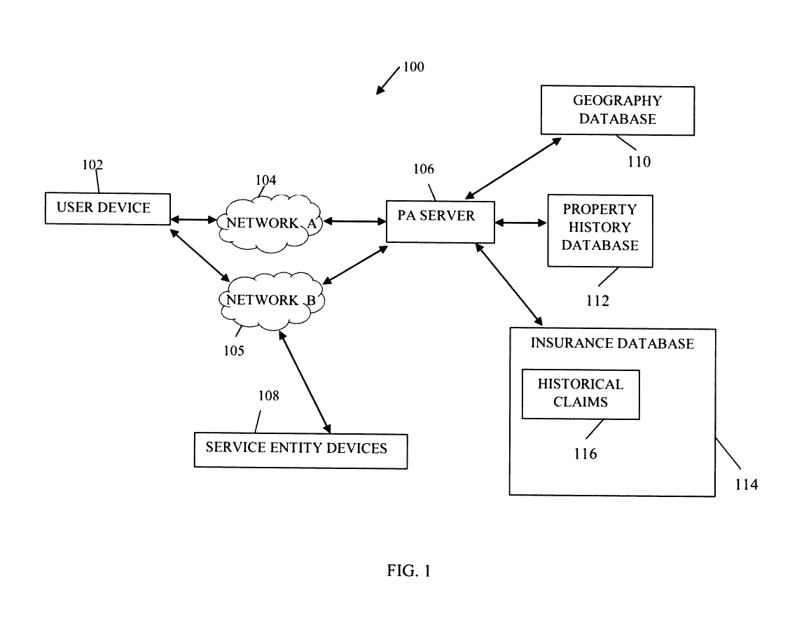

As illustrated in FIG. 1, the present disclosure relates in one embodiment to a network architecture 100 for enabling prescriptive analytics. In the illustrated embodiment, the architecture 100 comprises at least one user device 102 in communication with a PA server 106 via a first network, Network A 104, although it will be appreciated that the server (or multiple such servers) may be configured to interface with multiple clients or user devices simultaneously, and via two or more different networks. The PA server 106 obtains data relating to an incident from the user device 102. In one embodiment, the user device 102 provides information relating to the location of the damage(s) on the property. For example, when the property comprises a vehicle, the user device 102 may provide information that the damage is to the right front bumper, front passenger door, etc. The information may further include information relating to an extent of damages, time of the incident, speed or velocity, weather and other relevant conditions, identity and/or demographics of the parties, and geographic location, etc. The foregoing information is obtained from the user device 102 via text input (such as via email, instant messaging, or text messaging), speech (using speech recognition at the PA server 106), and/or via an automated process. The automated process for example, may be triggered upon the user device 102 calling a particular phone number, then run through a series of questions to which his responses are spoken and recorded, or entered via pressing a particular digit which corresponds to the correct answer. It will also be appreciated that some or all of the desired data/information may be obtained via, e.g., direct or indirect communication with the vehicle via a telematics system, such as the type now in existence which automatically obtain “over-the-air” signals and updates based on data derived from vehicle sensors such as crash detection units, accelerometers, speed sensors, GPS-based location, driver voice communications at time of crash or thereafter, occupancy sensors, “heartbeat” signals from one or more vehicle systems, “black box” information, and the like.

In another embodiment, information relating to an incident may be obtained automatically such as via a plurality of sensors located on the property, such as are discussed in co-owned, co-pending U.S. patent application Ser. No. 14/623,440 filed on Feb. 16, 2015 and entitled “APPARATUS AND METHODS FOR ESTIMATING AN EXTENT OF PROPERTY DAMAGE”, which is incorporated herein by reference in its entirety. As discussed therein, the PA server 106 or a historical database 108 in communication therewith receives a plurality of information relating to a current status of the at least one item. The plurality of information is collected by a plurality of sensor devices located on one or more surfaces of the at least one item. The plurality of information includes information such as the size of the area damaged, the specific areas damaged, the degree of deformation to the item, etc. In one exemplary embodiment, the sensor devices are multifunctional micro-sensors which cover substantially the entirety of the at least one item. The PA server 106 then evaluates the plurality of information relating to the current status of the at least one item to determine an estimate of damage (as discussed below).

Additionally, the aforementioned sensors disposed on an item may be utilized to constantly monitor the current state of the item. Information reporting the current state may be provided (via push or pull mechanisms) periodically, and/or only upon detection of a damage event. In this manner, the item owner can receive information relating to the damage of an item over time as well as upon the occurrence of a damage event. Moreover, the PA server 106 can determine an extent of damage due to a single incident as opposed to that damage aggregated over time, as discussed in the previously referenced U.S. patent application Ser. No. 14/623,440 and elsewhere herein.

The PA server 106 also obtains data relating to a plurality of previous incidents from one or more historical databases, which generally store data relating to a history of the customer and/or property which is asserted to be damaged. The data may be collected over a moving time-period window, or may comprise an unfiltered amount of data. Specifically, as shown in FIG. 1, geographic data is provided from one or more geography databases 110, property history (such as vehicle history) is provided from one or more property history databases 112, and data regarding a plurality of previous incidents is provided from an insurance database 114; the foregoing data is provided to the PA server 106 upon request therefor. Additional databases may include for example DMV records databases, Original Equipment Manufacturer records databases, and maintenance records databases.

The geography database 110 comprises information relating to the geography of a particular location. For example, the geography database 110 may include information from e.g., street maps, topographical maps, nearby physical or geographical features (such as canyons, lakes, etc.), nearby infrastructure or transportation elements (e.g., bridges, railroad tracks, and the like), etc., which is correlated to the property at the time of the incident. The geography database 110 may, in another embodiment, be configured to store GPS information associated with a specific location of the property at the time of the incident. Still further, the geography database 110 may store speed limit information corresponding to the street maps, etc. Therefore, the geography database 110 is able to provide to the PA server 106 information which enables the precise topography, street names, etc. at the time of the incident to be deduced. Information stored at the geography database 110 may be updated periodically such as from one or more online sources.

The property history database 112 comprises information relating to the history of the property. In the instance the property comprises a vehicle, for example, the property history database 112 may comprise a vehicle history database of the type well known in the art. Alternatively, the database may comprise Department of Motor Vehicles (DMV) records, and/or dealership or manufacturer records. Using this information the PA server 106 can determine whether a vehicle might be a “lemon”, whether there have been any safety recalls, whether the damages match to the description of the vehicle (i.e., detect fraud), etc. and may also assist the PA server 106 in determining the value of a vehicle for comparison against a cost to repair (which is estimated from information from the insurance database 114, discussed below).

Finally, the insurance database 114 comprises information relating to previous incidents. Specifically, the insurance database 114 stores historical claims information 116. Information 116 may include age (or age range), gender, a general description of the property, coverage details, general geographic area in which the property is registered. In one exemplary variant, the identity of the insured person is anonymized. The historical claims information 116 associates each of the insured persons to a previously submitted claim. Therefore the claim records 116 further comprise a listing of information which was utilized to establish conclusions in that claim regarding settlement amounts and appropriate services.

In one example, the claim records 116 list a plurality of measurable features, and a value for each. The measurable features may be obtained from the parties to the prior incident, or obtained from other sources such as from e.g., the insurance provider, a property history database 112, a geographic database 110, etc. The measurable features may include, e.g., year, make and model of the vehicle involved in the incident, age of the parties to the incident, demographics of the parties to the incident (such as age, gender, etc.), geographic location of the incident, speed and other conditions at the time of the incident, time of the incident, etc.

In the illustrated embodiment, the claims records 116 are generated and stored at the insurance database 114. However, in an alternative embodiment, the raw data may be collected and stored at the insurance database 114, then provided to the PA server 106 which generates the formatted records therefrom. In yet another embodiment, rather than generating an individual record for each prior incident, a plurality of similar incidents are generalized and combined into a single record. In one further embodiment, the foregoing databases (the geography databases 110, property history databases 112, and/or insurance databases 114) are located at the PA server 106 and not remote therefrom (as illustrated). Additionally, they may comprise a single database and/or any number of discrete databases whether located at or remote to the PA server 106.

Referring again to FIG. 1, the PA server 106 analyzes the historical data to derive a number of patterns. For example, the PA server 106 may begin by classifying previous claims data based on the service which was utilized to address the incident. Some examples of various services which may be used include e.g., a web-based application, a live agent, a repair facility, one or more salvage facilities, and/or rental car facilities. Hence, a pattern may be built using data collected from previously reported incidents which were best resolved by the customer using a web-based application.

Other patterns may be derived from the data, such as patterns of damages and/or injuries. For instance, it may be determined that traffic incidents reported as occurring at an intersection or on a highway have a higher level of damage and/or injury than those occurring in parking lots. It can be further determined that incidents occurring at particular geographic locations generally result in fault resting with one party and a specific array of damages and/or injuries. It may likewise be determined that certain customers have a higher ratio of injury to severity of the incident, which may be indicative of fraud. Other examples would derive from photographic, sensor or data inputs the damage severity to property and compare to similar manufacturer year makes and models, along with current market values to ascertain reparability.

The patterns are used, in one embodiment, as a comparison tool for information received from the user device 102 about a current incident. Specifically, information about a current incident is received via text, speech recognition, automation, and/or sensors. The information is then formatted into a data structure which resembles the data structure of the stored data and a one-to-one comparison is made. In one variant, certain ones of the measurable factors listed in the data structure are weighted differently than the simple one-to-one correlation discussed above. That is, an operator at the PA server 106 may manually identify certain ones of the factors which are to be given increased priority or weight and may enter a weighting value to be applied thereto.

Alternatively, the PA server 106 may run one of a plurality of pre-established programs which implement a pre-determined weighting system for all of the measurable factors. In this manner, various programs may be created to accomplish different business goals. For example, when screening for fraudulent activity, a specific pre-established program may weigh an injury to severity of the incident ratio higher than an age of the parties involved. Other such weighting schemes may be created by an operator at the PA server 106 and later selected when the operator is running data from a current or recent incident. Another example of a pre-determined weighting system would be analysis of a first notice of loss report in which a policyholder reports a loss and based on a series of questions and answers, which can be either structured or unstructured, would weigh and determine liability leading to a recommendation for course of action to resolve the claims most efficiently.

In either variant, the information relating to the current incident is compared to the prior data to determine a match using the weighting value (if necessary). That is to say, the level of correlation is weighted based on the operator's business goals. When a threshold level of correlation or correspondence (i.e., matching) is identified, a conclusion from the prior data is applied to the current incident.

Referring again to FIG. 1, the user device 102 and the PA server 106 are each in communication with a plurality of service entity devices 108 via a second network, Network B 105.

It is appreciated, however, that the two networks may comprise a single network in one embodiment. The PA server 106 and user device 102 communicate to the service entity devices 108 as will be discussed in greater detail below. In one variant, the service entity devices may include a repair facility, rental facilities, one or more salvage facilities, a web-based application, and/or a device associated to an insurance agent.

In one further variant, the PA server 106 and/or user device 102 may be in communication with a salvage network such as that disclosed in co-owned, co-pending U.S. patent application Ser. No. 14/572,660 entitled “APPARATUS AND METHODS FOR MANAGING DELIVERY OF ITEM INFORMATION AND FACILITATING A SALE OF AN ITEM” filed on Dec. 16, 2014 and incorporated herein by reference in its entirety. As discussed therein, a real-time auction for a plurality of items is provided the auction may occur at a salvage entity (i.e., one of the service entity devices 108 of FIG. 1) or at the PA server 106 itself. In one embodiment, an apparatus (at the salvage entity or PA server 106) receives a plurality of information relating to at least one item for auction. The plurality of information is sent by a client via a client device (such as user device 102). The plurality of information includes identification information (such as a vehicle identification number (VIN) or an insurance claim number (ICN)), item descriptive information (such as make, model, year, etc.), and/or damage description information (including photos and/or videos demonstrating the extent of damage). The apparatus then determines based at least in part on a profile thereof, individual ones of a plurality of salvage vehicle purchasers which are to receive a notification relating to the at least one item for auction. The profile is created when each one of the plurality of salvage vehicle purchasers creates an account to be notified for real-time auction opportunities. In one variant, the profile information may include a subscription level, or preferences such as (i) geographic parameters; (ii) item types; and/or (iii) an items cost. The apparatus (at the salvage entity or PA server 106) then based on the determination, transmits the notification to the individual ones of the plurality of salvage vehicle purchasers. The apparatus receives a plurality of offers to purchase the at least one item from respective ones of the salvage vehicle purchasers. The apparatus then enables an item information source to evaluate the plurality of offers. In one variant, the apparatus also enables the item information source to evaluate in addition to the plurality of offers, the respective ones of the individual ones of the plurality of salvage vehicle purchaser associated thereto, via a user interface. The apparatus then receives a selection of the bid that is the winning bid. The apparatus then transmits a notification to the salvage vehicle purchaser associated to the winning bid that the salvage vehicle purchaser bid for the particular item was accepted and selected as the winning bid.

In another embodiment, the foregoing concepts may be utilized to enable a machine learning or so-called “cognitive” system. In other words, the PA server 106 is configured to run at least one algorithm which makes predictions about a new incident based on what it has learned over time from previous incidents. In this manner, each new incident will not necessarily require the PA server 106 to run a completely new search of the databases for matching incident records; instead the previously determined patterns are consulted and implemented. The algorithm may include a statistics based pattern recognition. Data mining may also be utilized to discover patterns and knowledge from within the abundance of previous incident information stored at the one or more databases. Specifically, the data mining itself may include automatic or semi-automatic analysis of the previous incident information to extract previously unknown, interesting patterns such as groups of data records (cluster analysis), unusual records (anomaly detection), and dependencies (association rule mining). These patterns are then utilized, as discussed elsewhere herein for predictive analytics. In addition, a decision support system may be based at least in part on the identified patterns as also discussed herein.

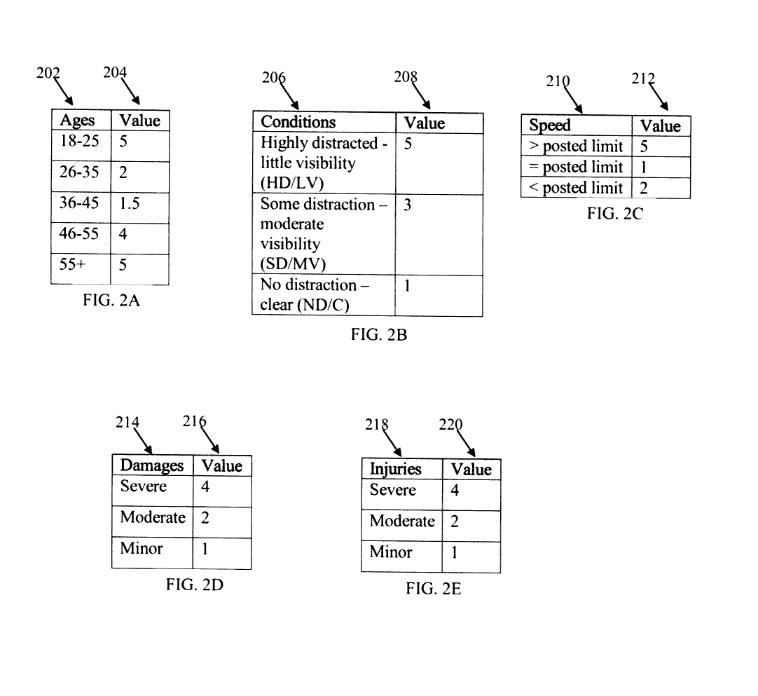

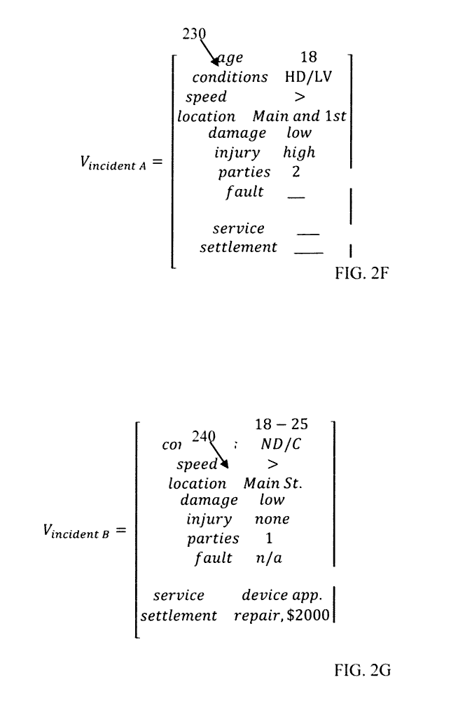

One exemplary operation of the foregoing architecture of FIG. 1 is disclosed in detail at FIGS. 2A-2G below.

Exemplary Operation—

FIGS. 2A-2G provide a simple example to illustrate the foregoing concepts with respect to a vehicle related incident. FIGS. 2A-2E illustrate exemplary weighting tables for a plurality of exemplary measurable factors. It is appreciated that the foregoing are merely exemplary, and not intended to represent an exhaustive list of the measurable factors and/or weighting schemes. As shown, for each of the measurable factors, a list of possible responses and a value by which each response is to be weighted is given. Accordingly, an operator at the PA server 106 is able to manipulate the weight applied to the measurable factors by adjusting the weighting values for the responses of each measurable factor. In one embodiment, a preloaded or pre-established set of values is provided when an operator selects a particular program. For example, different pre-established values may be given when an operator selects to analyze for determining fraud; yet different pre-established values may be given when the operator selects to analyze for determining an appropriate service to which the insured should be forwarded; and so forth. The preloaded values may be further modified by an operator, such as in the instance the results are inconclusive or unhelpful in attaining the operator's goal (i.e., estimating damages, determining fraud, determining an appropriate service, etc.). Alternatively, the operator may manually enter each of the values 204 for each analysis. In yet another embodiment, the operator entered changes and/or operator entered values may be saved as operator-specific analysis programs for future use by that or another operator.

Specifically, FIG. 2A illustrates a weighting table for the measurable factor of age (or age range) 202, which lists exemplary values 204 for each age range 202. In the illustrated embodiment, the age ranges 202 listed include 18-25; 26-35; 36-45; 46-55; and 55+; however, it is appreciated that other age ranges may be utilized including ones which more specifically align with relevant characteristics of common incidents. FIG. 2B illustrates a weighting table listing values 208 for the measurable factor of conditions 206. In the illustrated embodiment, the conditions 206 refer to both the distraction level and the driving conditions at the time of the incident. For example, the conditions 206 may include high, moderate, and no distraction coupled respectively with low, moderate, and clear visibility. In another variant, the driving conditions and values therefor may be provided separately from the distraction level and its values so as to provide increased granularity with respect to the weighting system. FIG. 2C illustrates a weighting table listing values 212 for the measurable factor of speed 210. As shown, various values are given to help weight instances where the insured is above the posted speed limit, at the posted speed limit, or below the posted speed limit at the time of the incident. FIGS. 2E and 2F illustrate values 216 and 220 when damages 214 and injuries 218 respectively are severe, moderate, and minor. Once again it is noted that the descriptions of the measurable factors for damages 214 and injuries 218 may comprise further detail than the simple descriptions: sever, moderate, and minor. For example, very specific types and locations of damages may be detailed such as e.g., front bumper dent, side door dent, wheel well damage; as well as very specific types of injuries such as e.g., head trauma, broken nose, air bag deployment burns, etc. each of the foregoing having a weighting value associated therewith as well.

Referring now to FIGS. 2F-2G, exemplary incident records are provided. FIG. 2F is an example of a current incident record 240; as shown the current incident record, V_{incident A}, has several pieces of information missing therefrom. FIG. 2G is an example of a previous incident record 230 such as that generated at the PA server 106 based on information obtained from the historical databases (such as the geography database 110, property history database 112, and/or the insurance database 114), labeled V_{incident B}.

Specifically, as illustrated in V_{incident A}, the current incident involves an insured at age 18, under high distraction or low visibility (HD/LV) conditions. The insured was traveling in excess of the posted speed limit at an intersection of Main and 1^{st} Streets. The damage associated with the incident was low; however, a high level of injuries were reported. Because there are multiple parties to the incident, fault must be determined. In addition, conclusions must be reached about: (i) settlement, and (ii) the appropriate service to which the insured should be forwarded. In order to reach these conclusions, a previous incident record is identified which significantly matches the conditions of V_{incident A}.

In one variant, the features which are present in V_{incident A} are compared to all of the records generated by (and saved at) the PA server 106. In another alternative, in order to save storage space at the PA server 106, a request message is sent from the PA server 106 to the insurance databases 114 which stores previous incident records. An operator at the PA server 106 may specify the threshold number of measurable features which must match those of the current incident, and/or may specify which of the measureable factors are of importance and which may be omitted when determining a match.

In order to determine a match and/or compare previous incident records with a current record, certain measurable factors are weighted more highly than other factors. In a simplified example, suppose the operator establishes that all other factors are given an ×1 weighting, whereas damage and injury are given ×2 weighting. By this scheme, when two or more records are compared the difference between the values listed for damage and injury is amplified.

In the present example, assuming the operator is in search of prior incident records which will assist in determining the appropriate service to which the insured should be forwarded, the operator may look specifically for previous incident records which match e.g., the age, location and damage of the current incident within a pre-determined or operator-entered level of variance. The measurable factors which are reviewed and allowed variance (using the aforementioned weighting factors) may be any which the operator selects or which are pre-determined as part of a pre-established program for determining a service, those discussed herein are merely illustrative. In this example, the operator may manually enter or select a pre-set program which sets the weighting of age, location and damage high, and the weighting value of all other measurable factors comparatively low. As each previous incident record is analyzed, the weighting factor is applied and used to identify one or more sufficiently matching records. In this example, the search returns the previous incident record shown as V_{incident B}, however it is appreciated that any number of records may be returned, and the operator may select only one, review each, and/or the PA server 106 may take an “average” or “mean” from the returned results (while indicating specific records which are outside of the average or mean).

As illustrated in V_{incident B}, the previous incident involved an insured in the 18-25 age range, in non-distracted or clear (ND/C) conditions. The insured was traveling in excess of the posted speed limit on Main St. The damage associated with the incident was low, and no injuries were reported. Therefore, the age, location and damages of the prior incident match the current incident. Accordingly, the PA server 106 causes the user device 102 of the current incident to be forwarded to the service which was used in the prior incident, i.e., the web-based application. In one variant this causes the device application to load on the user device so that the user (i.e., the insured) can move forward with the claims process. In another variant, the PA server 106 transmits a message to the user device which enables the user thereof to select a link which causes the device application to open and/or informs the user that he/she must proceed to open the device application. Similar mechanisms will apply in the instance the PA server 106 determines that the user device should place a telephone call or send a voice, text, or IM message to a live agent or repair facility (i.e., the connection may occur automatically, upon selection of a link, or a message may be sent to the user indicating the next step to be taken).

Continuing the present example, next the operator is in search of prior incident records which will assist in determining an estimated settlement. In order to accomplish this, the operator may look specifically for previous incident records which match e.g., the speed, location, damage and injury of the current incident within a pre-determined or operator-entered level of variance. The measurable factors which are reviewed and allowed variance (using the aforementioned weighting factors) may be any which the operator selects or which are pre-determined as part of a pre-established program for estimating a settlement, those discussed herein are merely illustrative. In this example, the operator may manually enter or select a pre-set program which sets the weighting of speed, location, damage and injury high, and the weighting value of all other measurable factors comparatively low. As each previous incident record is analyzed, the weighting factor is applied and used to identify one or more sufficiently matching records. In this example, the search once again returns the previous incident record shown as V_{incident B}, however it is appreciated that any number of records may be returned, and the operator may select only one, review each, and/or the PA server 106 may take an “average” or “mean” from the returned results (while indicating specific records which are outside of the average or mean).

As illustrated in V_{incident B}, the previous incident involved an insured who was traveling in excess of the posted speed limit on Main St. The damage associated with the incident was low, and no injuries were reported. Therefore, the speed, location and damages of the prior incident match the current incident. However, the injuries are inconsistent with those of the prior incident record. If it is determined, for example, that in a majority of similar incidents there is never or almost never injury reported, the may trigger the PA server 106 to begin reviewing the current incident for fraud. As noted above, a plurality of matching previous incident records may be provided from which this may be determined. That is to say, when there is a significant difference between only one of the measurable factors of the current incident and the previous incidents, the PA server 106 may further determine a likelihood that the difference is the result of fraud by reviewing other prior incidents. Alternatively, the determination that the identified record is the most relevant; and/or that the identified record represents the average or mean may be used as direct evidence that fraud has occurred. Based on the foregoing, the PA server 106 automatically or by operator direction, elects whether to use the settlement information from the identified prior incident, or to instead alert an agent that fraud analysis will be necessary. Similar mechanisms may be utilized for determine product liability and/or for determining whether any recall notices have been issued which may relate to the incident.

Assuming that the injury levels reported weren't different (as was not the case in the above example), the PA server 106 next simply notifies the insured, the insurance entity and/or a repair facility of the estimated repair amount.

Continuing the example from above, because there is a difference between the injuries reported in the current incident and those reported in previous incidents (as determined by examination of individual ones of a plurality of previous incident records and/or by taking an average of the previous records or a best matching record), fraud must be determined. A fraud inquiry may include e.g., the PA server 106 causing an operator to be placed into direct communication with the insured (such as via telephone, text, video, web-chat, etc.). In addition, when a possibility of fraud is detected, the PA server 106 may, without further operator input, search additional databases, such as the property history database. According to this embodiment, the PA server 106 may direct a search for information regarding a particular insured (or other party to an incident) or a particular vehicle among e.g., DMV records, other insurance company records, accident history reports, hospital records, OEM records, maintenance records, etc. An operator then utilizes the information obtained from the additional databases to make a determination as to whether a fraud is being committed in the current incident. In a further embodiment, another application at the PA server 106 analyzes information obtained from the additional databases to determine whether fraud is being committed in the current incident based on previously established standards for doing so. For example, the computer program may look for key words within the returned results from e.g., the DMV records and upon identification thereof, immediately cause a fraud remediation process to begin.

Fraud remediation may include, e.g., terminating coverage, notifying authorities, returning all coverage or settlement estimates to zero, and/or notifying the insured; each of which may occur automatically by the PA server 106 upon the determination thereof.

Returning again to the example of FIGS. 2F-2G, it is noted that the current incident record has two parties to the incident, whereas the previous incident record does not. Therefore, in order to make a determination of fault, a new incident record must be identified. Specifically, the operator may select manually or may select a pre-programmed application which specifically looks at features of: number of parties, speed, and conditions, with appropriate weighting factors applied thereto.

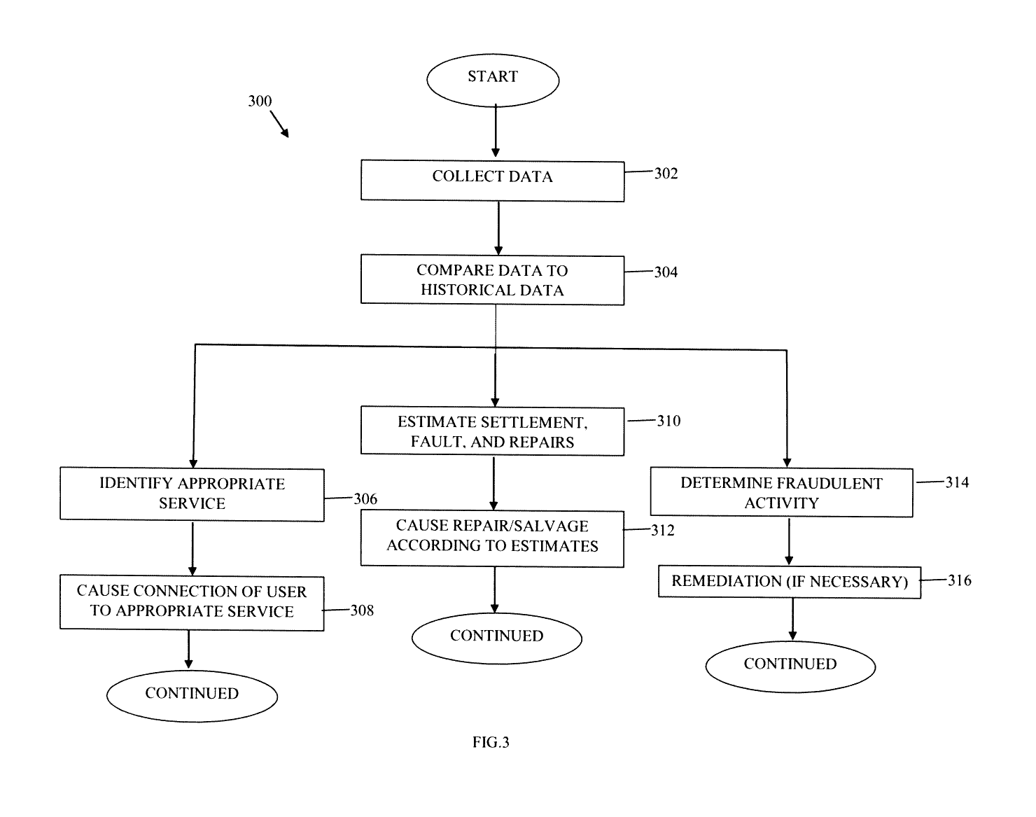

Exemplary methods of the exemplary embodiment of FIGS. 2A-2G as well as methods relating to the generalized architecture of FIG. 1 are described in detail at FIG. 3 below.

Methods—

FIG. 3 illustrates exemplary a method 300 for collecting data in order to prescribe and implement a course of action in accordance with the present disclosure.

Specifically, per step 302, data regarding a current incident is collected. The data may be collected via manual entry of text by a user into a mobile device or web-based application, may be collected orally then translated to text (either by a computer program or by an operator), may be obtained from a series of pictures (from which an operator generates textual descriptions), etc. In another embodiment, data may be received from a plurality of sensors disposed on the property as discussed in co-owned, co-pending U.S. patent application Ser. No. 14/623,440 filed on Feb. 16, 2015 and entitled “APPARATUS AND METHODS FOR ESTIMATING AN EXTENT OF PROPERTY DAMAGE”, incorporated by reference elsewhere herein.

The collected data is compared to a plurality of previous incident records at step 304. As noted above, in one embodiment patterns are extrapolated from the previous incident records, and the collected current incident record is compared to the patterns. Alternatively, the record may be compared to a number of previous records collected, which may or may not have been received within a moving window of time, so as not to be compared against outdate/irrelevant data. The PA server 106 enables an operator to select one or more measurable features and weight to be applied to each so that a search of the plurality of records yields only the most relevant ones thereof. The foregoing may be accomplished via implementation of a pre-established program of factors and weights determined to yield a desired result as discussed elsewhere herein. Additionally, an operator may manually adjust the variance of each measurable factor (such as when the number of returned previous incident records is greater or less than a threshold therefor) based on e.g., the results obtained from a first analysis; and/or this may be done automatically by the PA server 106.

One or more of the illustrated pathways may be taken by the PA server 106 at this point in the method.

Per step 306 of the first pathway, the analysis at step 304 results in a determination of an appropriate service to which the user device 106 should be forwarded. Some examples of various services which may be used include e.g., a web-based application, a live agent, a repair facility, one or more salvage facilities. Additionally, a salvage network such as that described in co-owned, co-pending U.S. patent application Ser. No. 14/572,660 entitled “APPARATUS AND METHODS FOR MANAGING DELIVERY OF ITEM INFORMATION AND FACILITATING A SALE OF AN ITEM” filed on Dec. 16, 2014, incorporated by reference elsewhere herein may be utilized.

Finally, per step 308, the PA server 106 causes the user device 102 to be forwarded to the appropriate service. In the example illustrated above with respect to FIGS. 2F-2G, the PA server 106 causes the user device 102 of the current incident to be forwarded to the service which was used in the prior incident, i.e., the device application. The device application loads on the user device so that the user (i.e., the insured) can move forward with the claims process. In another variant, at step 308, the PA server 106 transmits a message to the user device which enables the user thereof to select a link which causes the device application to open and/or informs the user that he/she must proceed to open the device application. In another alternative, at step 308, the PA server 106 causes the user device to place a telephone call or send a voice, text, or IM message to a live agent or repair facility (i.e., the connection may occur automatically, upon selection of a link, or a message may be sent to the user indicating the next step to be taken).

Referring now to step 310 of the second pathway, the analysis at step 304 results in a determination of an estimate as to settlement, fault and/or repairs. That is to say, as noted above, the operator selects at step 304 optimized variables for determining an estimated settlement, fault and/or repairs by manipulating the weight or variance allowed for each measurable factor, or may select a program at the PA server 106 which automatically implements variance for each measurable factor based on the desired outcome (e.g., estimations of the foregoing).

Finally, per step 312, the PA server 106 causes the repair/salvage entities to proceed according to the estimates. For example, the PA server 106 may, based on the determined estimate (step 310) send a message to a repair facility indicating that a specific type of work at a specific cost is to be performed in associating with a given incident (e.g., repairs to side door, and wheel well not to exceed $2000). The PA server 106 may also cause the salvage network to begin providing an auction of the property as disclosed in previously referenced co-owned, co-pending U.S. patent application Ser. No. 14/572,660.

In a further embodiment, the PA server 106 may at step 312 notify the insured of the estimated repairs and/or determined salvage status. This may be performed simultaneous to the previously disclosed act of causing the salvage entity and/or repair entity to proceed according to a determined estimate.

Referring now to step 314 of the third pathway, the analysis at step 304 results in a determination of whether fraudulent activity has occurred and per step 316 remediation is performed (if necessary). A fraud inquiry at step 314 may include (i) the PA server 106 causing an operator to be placed into direct communication with the insured; (ii) without further operator input, the PA server 106 causing search of additional databases to be performed; and/or (iii) the PA server 106 analyzing information obtained from the additional databases.

Fraud remediation per step 316 may include, e.g., terminating coverage, notifying authorities, returning all coverage or settlement estimates to zero, and/or notifying the insured.

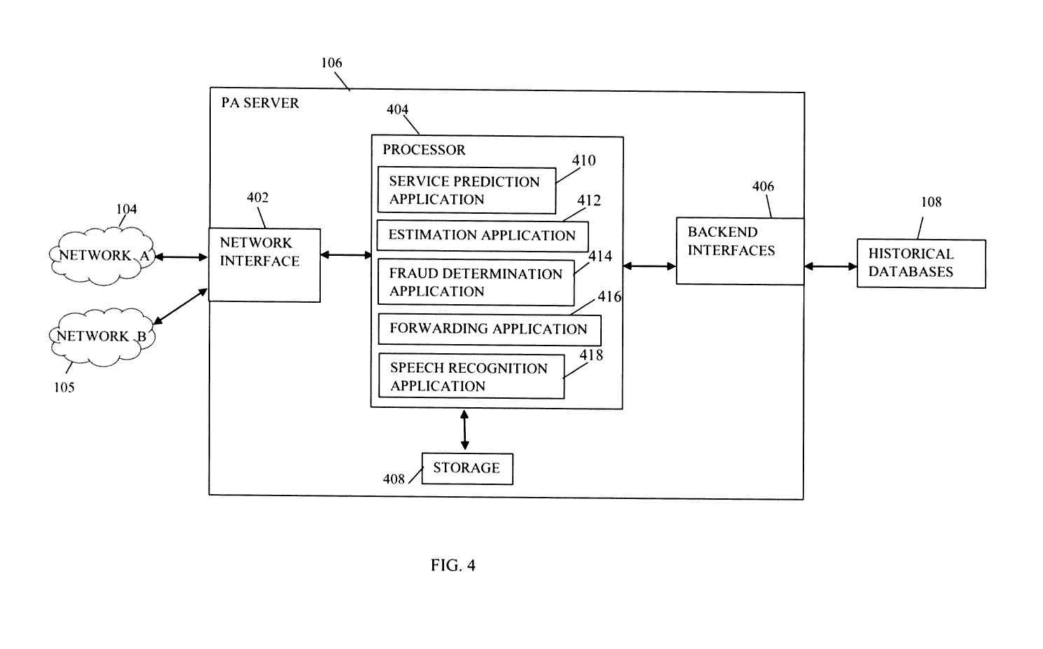

An exemplary PA server 106 as discussed throughout the disclosure is described in further detail with respect to FIG. 4 below.

### Exemplary Prescriptive Analysis Server—

FIG. 4 is a block diagram illustrating an exemplary PA server 106 in accordance with the present disclosure. As shown, the PA server 106 generally comprises a network interface 402 for communication with various networks (e.g., Network A 104 and Network B 105), a digital processor 404, various backend interfaces 406 for communication to other devices and databases (such as via any number of additional networks), and a storage device 408. Although illustrated as a single device, it is appreciated that the PA server 106 may comprise any number of distinct devices and form factors.

As noted previously, the network interface 402 enables communication between the PA server 106 and a plurality of user devices 102 as well as service entity devices 108. Communication with user devices 102 may include direct communication such as manual entry of text by a user or spoken words to an appropriate application run at the PA server 106, as well as manual or spoken communication from an operator at the PA server 106 to a user device 102 or service device 108. In another embodiment, the communication may include automatic communications between the devices and PA server 106 i.e., those transmitted without user input, such as via the previously disclosed sensor array, automatic delivery of estimate information, automatically placing two devices in communication with one another, etc. The backend interfaces 406 enable direct user to user or automatic (i.e., without direct user input) communication between the PA server 106 and one or more additional networks, devices or databases as discussed above. Additionally, it is noted that the backend interfaces and network interface may comprise a single network interface configured to interface with one or more networks which enable communication to e.g., the user devices 102, the service entity devices 108 (including insurance agent devices and salvage entity devices), and the various databases (e.g., the geography database 110, property history database 112, and insurance database 114).

The storage device 408 of the PA server 106 is, in one embodiment, configured to store processed and formatted historical or previous incident records as well as incoming current incident data or formatted records thereof. In one embodiment, the incident records may relate to vehicle incidents. In another embodiment, the records relate to other incidents involving property damage and/or physical injury or illness involving medical care. In addition, the storage device 408 may be configured to store one or more computer programs or applications which are executed by the processor 404.

As illustrated, the PA server 106 further comprises a digital processor 404, which, in one embodiment, is configured to run one or more computer programs (stored at the storage apparatus 408), the computer programs are configured to cause the PA server 106 to managing a collection of data in order to prescribe and implement a course of action. Specifically, in the illustrated embodiment, the processor 404 is configured to execute a service prediction application 410, an estimation application 412, a fraud determination application 414, a forwarding application 416, and a speech recognition application 418.

The service prediction application 410, the estimation application 412, and the fraud determination application 414, each comprises a plurality of instructions which, when executed by the processor 404, cause the PA server 106 to analyze a current incident record against one or more of a plurality of historical records and/or request additional information from e.g., the property history database, DMV records, other insurance company records, accident history reports, hospital records, etc. In one variant each of the foregoing applications comprises a pre-determined set of weighted ones of the measurable factors. The weighting scheme may be configured to be manually adjusted by an operator or automatically adjusted based on results obtained.

For example, the service prediction application 410 may include a weighting scheme which values the age, location and damage of the current incident higher than other measurable factors. The measurable factors may be within a pre-determined range and/or within a given level of variance. In another example, when determining an estimated settlement, the estimation application 412 may comprise weighting or adjustments to more closely scrutinize the speed, location, damage and injury of previous incident records. Finally, the fraud determination application 414 may comprise a weighting scheme which focuses on finding significant differences between one of the measurable factors of the current incident and the previous incidents. The illustrated applications are intended to be merely exemplary, it is appreciated that a plurality of additional applications or programs to analyze for other patterns, etc. may be utilized consistent with the present disclosure as well.

In addition to the pattern determination applications discussed above, the processor 404 is further configured to run a forwarding application 416 and a speech recognition application 418. The forwarding application 416 comprises a plurality of instructions which, when executed by the processor 404, enable the PA server 106 to cause a device to be forwarded to a service. For example, once the appropriate service is determined using the service prediction application 410, the forwarding application 416 at the PA server 106 causes the user device 102 of the current incident to be forwarded to that service. In one variant this causes the device application or web-based application to load on the user device 102 so that the user (i.e., the insured) can move forward with the claims process. In another variant, the forwarding application 416 transmits a message to the user device 102 which enables the user thereof to select a link which causes the device application to open and/or informs the user that he/she must proceed to open the device application. Similar mechanisms will apply in the instance the service prediction application 410 determines that the user device should place a telephone call or send a voice, text, or IM message to a live agent or repair facility (i.e., the connection may occur automatically, upon selection of a link, or a message may be sent to the user indicating the next step to be taken).

The speech recognition application 418 comprises a plurality of instructions which, when executed by the processor 404, enable the PA server 106 to match unstructured data to various measurable factors and derive a current incident record therefrom. In other words, in one variant, data is collected from a user/insured via oral communication therewith (either through the user calling in and answering questions from a recording or a live agent). The data derived from the telephone call is analyzed by the speech recognition application 418 and formatted into an incident record such as those discussed above with respect to FIGS. 2F-2G, to be used in further analysis. In a further variant, the speech recognition application 418 may be tuned or modified to “listen” for certain key words. When a particular key word is heard, a new line of questioning may be presented and/or certain measurable features may be deduced. Inconsistencies in a disclosure meeting may be further made evident using the keywords, thereby alerting the operator to potential fraud.

It is also appreciated that the methods of the present disclosure may be practiced using any configuration or combination of hardware, firmware, or software, and may be disposed within one or any number of different physically or logically distinct entities. Myriad different configurations for practicing the disclosure will be recognized by those of ordinary skill in the art given the present disclosure.

The PA server 106 can also be masked or controlled by a “business rules engine” or other logical wrapper or layer as described subsequently herein.

### Service Efficiency—

It is appreciated that the foregoing methods and apparatus may advantageously be used to increase efficiency of service.

In one embodiment, the PA server 106 is able to pre-approve an insured for repairs up to a certain amount, and may even approve specific repairs and/or replacement or repair of specific parts. That is to say, at the time the incident record is created, the PA server 106 will be able to instantaneously determine the estimated repairs and transmit these to the insured and/or one or more repair facilities.

In another embodiment, reminders/alerts, tracking and time estimates may be provided via the PA server 106. Specifically, the previous incident records may further include measurable factors which indicate certain milestones in progression of a claim and a timeline for each. For example, a pattern may appear in the previous incident records that indicates that one day after a minor incident including a broken windshield was reported, the replacement parts were received, and two days after the incident was reported, the repairs were complete. From this information, the PA server 106 may send reminders/alerts as to the estimated status of the repairs, updated messages which track the progress of the repairs, and provide an estimate of time remaining and/or anticipated completion date. In one further variant, the foregoing reminders/alerts, tracked progress and time estimate are provided on a single interface available to the insured via e.g., a device or web-based application managed by the PA server 106.

In yet another embodiment, the PA server 106 is further configured to run an application which enables it to learn a particular user's preferences and/or preferences of a given demographic. For example, the application may recognize that users aged 18-25 are more likely to request that their claim be processed through the device or web-based application and therefore, may forward a device of a user in this demographic to that service. In another example, it may be determined that users aged 35-55 are more likely to request a rental or loaner car, and therefore may be forwarded to that service.

### Business Rules and Considerations—

Various exemplary business-related aspects of present disclosure are now described in detail.

In one embodiment, access to the various ones of the above-described features of the PA server 106 are featured as part of one or more optional subscription plans. For example, access to the time estimate and/or alarm/reminder feature may be charged at a premium over more basic services to a user. Additionally, the service providers (i.e., insurance companies, repair facilities, salvage facilities, rental car facilities, etc.) may be charged a premium for the aforementioned forwarding services.

In another aspect of the disclosure, the aforementioned processor 404 running on the PA server 106 (one or more computer programs located thereon) includes a so-called “rules” engine. These rules may be fully integrated within various entities associated with the present disclosure. In effect, the rules engine comprises a supervisory entity which monitors and selectively controls the incident information acquisition, analysis, and forwarding/delivery functions at a higher level, so as to implement desired operational or business rules. The rules engine can be considered an overlay of sorts to the remote content management and delivery algorithms.

Many other approaches and combinations are envisaged consistent with the disclosure, as will be recognized by those of ordinary skill when provided this disclosure.

It should be recognized that while the foregoing discussion of the various aspects of the disclosure has described specific sequences of steps necessary to perform the methods of the present disclosure, other sequences of steps may be used depending on the particular application. Specifically, additional steps may be added, and other steps deleted as being optional. Furthermore, the order of performance of certain steps may be permuted, and/or performed in parallel with other steps. Hence, the specific methods disclosed herein are merely exemplary of the broader methods of the disclosure.

It will be further appreciated that while certain steps and aspects of the various methods and apparatus described herein may be performed by a human being, the disclosed aspects and individual methods and apparatus are generally computerized/computer-implemented. Computerized apparatus and methods are necessary to fully implement these aspects for any number of reasons including, without limitation, commercial viability, practicality, and even feasibility (i.e., certain steps/processes simply cannot be performed by a human being in any viable fashion).

While the above detailed description has shown, described, and pointed out novel features of the disclosure as applied to various embodiments, it will be understood that various omissions, substitutions, and changes in the form and details of the device or process illustrated may be made by those skilled in the art without departing from the disclosure. The described embodiments are to be considered in all respects only illustrative and not restrictive. The scope of the disclosure is, therefore, indicated by the appended claims rather than the foregoing description. All changes that come within the meaning and range of equivalence of the claims are embraced within their scope.

What is claimed is:

1. An apparatus configured to prescribe a user action based on a plurality of historical data, said apparatus comprising:
a first interface configured to:
receive from a user device a first data record comprising information relating to a first incident;
receive from at least one historical database a plurality of second data records, each of said second data records corresponding to individual ones of a plurality of second incidents;
a storage apparatus; and
a processor in data communication with said storage apparatus and configured to execute at least one computer program stored thereon, said computer program comprising a plurality of instructions which are configured to, when executed by said processor:
compare one or more aspects of said first data record to one or more patterns identified in said plurality of second data records to identify one of said one or more patterns to which said first data record corresponds; and
cause said user device to be automatically connected to a specific one of a plurality of services based at least in part on said identified one of said one or more patterns.

2. The apparatus of claim 1, wherein said first data record comprising information relating to said first incident is generated via a speech recognition application configured to run at a device to which said party is in communication.

3. The apparatus of claim 1, wherein said plurality of second data records each comprises a respective plurality of aspects, and said one or more patterns comprise at least one pattern which relates certain ones of said plurality of aspects of said second data records to one of said plurality of services.

4. The apparatus of claim 1, wherein said first incident comprises a vehicle collision and said plurality of services comprise one or more of: a vehicle insurance claims agent, a vehicle salvage facility, and a vehicle repair facility.

5. The apparatus of claim 4, wherein said automatic connection to said specific one of said plurality of services comprises at least one of: causing said user device to place a telephone or internet call to at least one of a vehicle insurance claims agent, a vehicle salvage facility, and a vehicle repair facility; and causing said user device to launch a web-based application for submitting a vehicle insurance claim.

6. The apparatus of claim 1, wherein said plurality of instructions are further configured to, when executed by said processor:
format said first data record into a format configured to correspond to a format utilized by said at least one historical database for said plurality of second data records; and
examine said plurality of second data records to extrapolate said one or more patterns therefrom.

7. A method for connecting a user to a service needed at a time of an incident involving property damage in real-time, said method comprising:
receiving information relating to said incident, said information comprising values of certain ones of a plurality of measurable factors;
deriving a data record from said information, said data record configured to correspond to a format of a plurality of historical data records;
comparing said values of said data record to respective values of individual ones of a plurality of measurable factors of each of said plurality of historical data records; and
when a threshold number of said values of said data record correspond to said values of individual ones of said plurality of measurable factors of a first one of said plurality of historical data records, causing said user to be automatically connected to a service associated with said first one of said plurality of data records.

8. The method of claim 7, wherein said incident involving property damage and said plurality of specific historical incidents each comprise vehicle collisions; and said plurality of measurable factors include one or more of: extent of damages, demographics of one or more parties, and geographic location.

9. The method of claim 8, wherein said service to which said specific historical incident may be routed includes one or more of: a web-based application for submitting a vehicle insurance claim, a vehicle insurance claims agent, a vehicle salvage facility, and a vehicle repair facility.

10. The method of claim 8, said act of comparing further comprises:
receiving said plurality of historical data records, each of said plurality of historical data records being configured to represent a respective one of a plurality of specific historical incidents and having a first plurality of data entries comprising said values for each of said plurality of measurable factors, and a second data entry comprising a service to which said specific historical incident may be routed.

11. The method of claim 7, further comprising based at least in part on said comparison, determining at least one of: whether said incident involving property damage is fraudulent; and a fault associated with said incident involving property damage.

12. The method of claim 7, further comprising based at least in part on said comparison, estimating at least one of: an amount which repairs associated with said incident involving property damage will cost; and an amount which settlement for injuries associated with said incident involving property damage will cost.

13. The method of claim 8, wherein said automatic connection to said service associated with said first one of said one or more classes comprises causing a user device associated to said user to place a telephone or internet call to at least one of a vehicle insurance claims agent, a vehicle salvage facility, and a vehicle repair facility.

14. The method of claim 8, wherein said automatic connection to said service associated with said first one of said one or more classes comprises causing a user device associated to said user to launch a web-based application for submitting a vehicle insurance claim.

15. A non-transitory computer readable apparatus comprising a storage medium, said storage medium comprising at least one computer program having a plurality of instructions, said plurality of instructions configured to, when executed by a processing apparatus:
obtain data regarding a current incident from a party to said incident;
receive a plurality of historical data regarding a plurality of previous incidents from one or more historical databases; and
compare said data regarding said current incident to said plurality of historical data and based on said comparison cause one or more entities in communication therewith to automatically perform an action.

16. The apparatus of claim 15, wherein said data regarding said current incident is obtained via a speech recognition application configured to run at a device to which said party is in communication.

17. The apparatus of claim 15, wherein said data regarding said current incident comprises a plurality of values relating to a respective plurality of measurable factors, and said each of said plurality of historical data comprises a first plurality of data entries comprising values for each of a respective plurality of measurable factors, and a second data entry comprising a service to which said specific historical incident may be routed.

18. The apparatus of claim 17, wherein said comparison comprises:
classifying said plurality of historical records into one or more classes based on said service to which said specific historical incident may be routed; and
comparing said values of said data record to said values of individual ones of said plurality of measurable factors of each of said classes of said historical data records.

19. The apparatus of claim 15, wherein said action comprises one or more of:
a determination of whether said incident is fraudulent;
automatically forwarding a user device associated with said party to a resolution service;
a determination of fault associated with said incident;
an estimation of an amount which repairs associated with said current incident will cost; and
an estimation of an amount which settlement for injuries associated with said current incident will cost.

20. The apparatus of claim 19, wherein said automatic forwarding comprises:
when a threshold number of said values of said data record correspond to said values of individual ones of said plurality of measurable factors of a first one of said one or more classes, said user is automatically connected to said service associated with said first one of said one or more classes.
